(19) United States
(12) Patent Application Publication
(10) Pub. No.: US 2021/0294119 A1
(43) Pub. Date: Sep. 23, 2021

(54) DISPLAY APPARATUS FOR RENDERING THREE-DIMENSIONAL IMAGE AND METHOD THEREFOR

(71) Applicant: Lightspace Technologies, SIA, Marupes novads (LV)

(72) Inventors: Ilmars Osmanis, Marupes novads (LV); Kriss Osmanis, Babites novads (LV); Martins Narels, Riga (LV); Rendijs Smukulis, Riga (LV); Marcis Greitans, Garkalnes novads (LV); Roberts Zabels, Riga (LV)

(73) Assignee: Lightspace Technologies, SIA, Marupes novads (LV)

(21) Appl. No.: 16/821,449

(22) Filed: Mar. 17, 2020

(51) Int. Cl. G02B 30/52; G02B 27/01; G02B 27/14; G09G 3/00

(52) U.S. Cl. CPC G02B 30/52; G02B 27/0172; G02B 27/144; G09G 2320/08; G02B 2027/0134; G02B 2027/014; G09G 2300/023; G09G 3/003

(57) ABSTRACT

A display apparatus for presenting three-dimensional imagery, including an optical combiner having a first side, a second side, a third side and a fourth side. The second side is opposite to the first side and the fourth side being is opposite to the third side. Optical combiner further includes a first semi-transparent reflective portion arranged to reflect light incoming from the first side towards the fourth side and a second semi-transparent reflective portion arranged to reflect light incoming from the second side towards the fourth side. Light incoming from the third side passes through the first semi-transparent reflective portion and the second semi-transparent reflective portion towards the fourth side. The display apparatus further includes of a first display, a second display and a third display arranged at a first distance, a second distance and a third distance from the first side, the second side and the third side of the optical combiner, respectively, wherein a first image, a second image and a third image rendered at the first display, the second display and the third display are presented at a first focal distance, a second focal distance and a third focal distance, respectively, thereby creating the three-dimensional image.

### TECHNICAL FIELD

The present disclosure relates generally to display arrangements; and more specifically to multifocal stereoscopic display arrangements for rendering a three-dimensional image, in a view of real-world environment. Furthermore, the present disclosure also relates to methods for rendering the three-dimensional image.

### BACKGROUND

With the advancements in technology, three-dimensional (3D) content visualization has gained popularity in the recent years as information, data, objects, models and so forth visualized in three-dimensional (3D) format are effectively perceived and retained by the human brain. Therefore, three-dimensional imagery is used in the fields of education (for example, to show three-dimensional models to students at schools and colleges), civil engineering, air traffic control management (for example, to model airspace surrounding an airport), architecture, medicine, research and science, military and defence (for example, to depict topographical models of battlefields), and the like.

To represent three-dimensional objects and scenes, three-dimensional display technologies such as stereoscopic displays, including head-mounted displays, helmet-mounted displays and the like are employed. Currently, stereoscopic displays utilize conventional two-dimensional imaging solutions allowing presenting only psychological depth cues and limited physical depth cues to imitate depth and thus cannot correctly drive accommodation and convergence (referred to as vergence accommodation conflict). The vergence accommodation conflict arises from the fact, that a single focal plane is used, which forces the accommodation of human visual system to be fixed at all instances on this plane, to form a sharp image on a retina, while vergence (angular eye-movements) can be arbitrarily adapted to the shown content. Thus, these depth-sensing mechanisms, which naturally are linked, become decoupled, which can cause unpleasant sensations to the viewer and thus limit the viewing time, and can also cause human errors based on inadequate decision making due to incorrectly or imprecisely perceived 3D information.

The problem associated with vergence-accommodation conflict inhibits wide penetration of stereoscopic display devices in professional and consumer markets, as it negatively impacts user experience causing excessive eyestrain, blurry vision, possibly nausea. The effects become more severe, when the 3D content is rendered to be perceived closer to the observer, where the mismatch between accommodation and vergence rapidly increases. In contrast, when the content is rendered at far distances, this mismatch may be easily tolerable by majority of viewers. This makes conventional stereoscopic displays ill-suited for near-work oriented tasks, especially considering augmented or mixed reality applications.

To overcome limitations inflicted by vergence-accommodation conflict, several solutions have been proposed. One of the most notable approaches is varifocal stereoscopic displays. As the task is to match the plane of accommodation to the value of eye vergence, which inherently cancels out the mismatch between accommodation and vergence, in varifocal solution, the position of focal plane is varied in accordance to the vergence value of the observer's eyes. Such a system inherently requires an eye or gaze tracking devices, to record the vergence value. A method for varying the focal distance of the image plane can differ; for example, it can be either a reciprocating screen actuated by electronic motors or alternatively it can be a varifocal lens, which upon control signal can change its optical strength. Nonetheless, varifocal stereoscopic displays may not be able to address issue of blur cues, which are important depth cue. To overcome this, synthetic (computational) pre-filtering of image is utilized to introduce computationally determined blur based on the eye position. On one hand, the synthetic blur is not a direct match to actual retinal blur but on the other hand it adds additional computational burden. Furthermore, utilization of eye-tracking devices, may introduce a notable time-lag, which can be negatively perceived by the observer. If computational time of synthetic blur is also taken into account, the possibility of time-lag increases. Moreover, as varifocal systems require some sort of electromechanical actuation devices to ensure scanning of multiple focal distances in response to the value of eye vergence, they typically are associated with bulk. Thus, the varifocal approach can be successfully utilized in virtual-reality headsets, where space is typically not a primary concern, nonetheless, the varifocal system is not suitable for augmented reality or see-through displays, where additional volume is occupied by image combiner and other optics ensuring see-through capability. Nevertheless, these approaches involve moving parts which can be overly complicated, or being subjected to low image refresh rate which may cause flicker and, in turn, strain human visual system and cause motion sickness due to slow content updates.

Alternative way of overcoming vergence accommodation conflict and ensuring out-of-focus retinal blur is by utilizing light field displays. Herein, an observer's eyes are presented with views from multiple viewpoints which allow refocusing capability. One of the ways is to utilize a microdisplay (and OLED or LCD display), which is coupled with a lenslet array, where each lens of the array reimages a corresponding area of the display. Thus, the microdisplay is segmented into multiple views with reduced resolution. The obvious drawback of such an approach is in overall low-resolution imagery, as very high-resolution micro displays are not readily available. Alternative method is to utilize a reflective-type spatial light modulator in conjunction with an array of point light sources. In such case, each point light source would illuminate the spatial light modulator from a different angle giving rise to multiple views. In contrast, the achievable image resolution is high, nevertheless, utilization of time-multiplexed principle has to be employed. The time multiplexing among different views requires the spatial light modulator to operate at substantially high image refresh rates to ensure a flicker-free operation. With currently available spatial light modulators, if true colour reproduction has to be considered, the maximum number of light fields becomes limited or alternatively if a higher number of views is desired, either image refresh rate or colour depth becomes impaired.

Therefore, in light of the foregoing discussion, there exists a need to overcome various problems associated with conventional displays especially for near-work oriented depiction of three-dimensional content, as in purely virtual reality environments (for example training of medics and surgeons), and for augmented reality scenarios, such as image assisted production and assembly, real-time live image assisted medical procedures and the like.

### SUMMARY

The present disclosure seeks to provide a display apparatus and a method for rendering three-dimensional image, and specifically addresses problems related to generally low image refresh rate in multifocal displays to yield benefits of multifocal display architecture with high fidelity imagery. The present disclosure teaches about implementation of multifocal display architecture for wearable stereoscopic, as well as monocular display systems. An aim of the present disclosure is to provide a solution that overcomes at least partially the problems encountered in prior art, and provides a display apparatus to provide a truthful representation of a three-dimensional image.

In one aspect, an embodiment of the present disclosure provides a display apparatus for rendering a three-dimensional image, comprising:

an optical combiner having a first side, a second side, a third side and a fourth side, the second side being opposite to the first side, the fourth side being opposite to the third side, the optical combiner comprising:

a first semi-transparent reflective portion arranged to reflect light incoming from the first side towards the fourth side; and

a second semi-transparent reflective portion arranged to reflect light incoming from the second side towards the fourth side,

wherein light incoming from the third side passes through the first semi-transparent reflective portion and the second semi-transparent reflective portion towards the fourth side; and

a first display, a second display and a third display arranged at a first distance, a second distance and a third distance from the first side, the second side and the third side of the optical combiner, respectively, wherein a first image, a second image and a third image rendered at the first display, the second display and the third display are presented at a first focal distance, a second focal distance and a third focal distance, respectively, thereby creating the three-dimensional image.

In another aspect, an embodiment of the present disclosure provides a method for rendering a three-dimensional image, comprising:

providing an optical combiner having a first side, a second side, a third side and a fourth side, the second side being opposite to the first side, the fourth side being opposite to the third side, the optical combiner comprising a first semi-transparent reflective portion arranged to reflect light incoming from the first side towards the fourth side; and a second semi-transparent reflective portion arranged to reflect light incoming from the second side towards the fourth side, wherein light incoming from the third side passes through the first semi-transparent reflective portion and the second semi-transparent reflective portion towards the fourth side;

arranging a first display, a second display and a third display at a first distance, a second distance and a third distance from the first side, the second side and the third side of the optical combiner, respectively; and

rendering a first image, a second image and a third image at the first display, the second display and the third display such that the first image, the second image and the third image are presented at a first focal distance, a second focal distance and a third focal distance, respectively, thereby creating the three-dimensional image.

Embodiments of the present disclosure substantially eliminate or at least partially address the aforementioned problems in the prior art, and enable truthful depiction of the three-dimensional image. Further, the represented three-dimensional images have an enhanced psychological depth cues and physical depth cues to correctly imitate depth associated with an image being viewed by the viewer. Additionally, the experience of the viewer is further enhanced by combining the view of real-world environment to the image being viewed.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a display apparatus for rendering a three-dimensional image, in accordance with an embodiment of the present disclosure;

FIGS. 2 and 3 are schematic illustrations of display apparatuses for rendering respective three-dimensional images, in accordance with various embodiments of the present disclosure;

FIG. 4 is a schematic illustration of a display apparatus implemented as a wearable display device for rendering a three-dimensional image, in accordance with an embodiment of the present disclosure;

FIG. 5 is schematic illustration of a display apparatus for rendering a three-dimensional image, in accordance with an exemplary implementation of the present disclosure;

FIG. 6 is a block diagram of a display apparatus for rendering a three-dimensional image, in accordance with another exemplary implementation of the present disclosure;

FIG. 7 is a flowchart listing steps of a method for rendering a three-dimensional image, in accordance with an embodiment of the present disclosure;

FIG. 8 is depiction of a rendered three-dimensional image with selective blur, in accordance with an embodiment of the present disclosure;

FIG. 9 is a flowchart listing steps of a method for rendering a three-dimensional image, in accordance with another embodiment of the present disclosure; and

FIGS. 10A-10C are schematic illustrations of different configurations of display apparatus for rendering a three-dimensional image, in accordance with various exemplary implementations of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In one aspect, an embodiment of the present disclosure provides a display apparatus for rendering a three-dimensional image, comprising:

an optical combiner having a first side, a second side, a third side and a fourth side, the second side being opposite to the first side, the fourth side being opposite to the third side, the optical combiner comprising:

a first semi-transparent reflective portion arranged to reflect light incoming from the first side towards the fourth side; and second semi-transparent reflective portion arranged to reflect light incoming from the second side towards the fourth side,

wherein light incoming from the third side passes through the first semi-transparent reflective portion and the second semi-transparent reflective portion towards the fourth side; and

a first display, a second display and a third display arranged at a first distance, a second distance and a third distance from the first side, the second side and the third side of the optical combiner, respectively, wherein a first image, a second image and a third image rendered at the first display, the second display and the third display are presented at a first focal distance, a second focal distance and a third focal distance, respectively, thereby creating the three-dimensional image.

In another aspect, an embodiment of the present disclosure provides a method for rendering a three-dimensional image, comprising:

providing an optical combiner having a first side, a second side, a third side and a fourth side, the second side being opposite to the first side, the fourth side being opposite to the third side, the optical combiner comprising a first semi-transparent reflective portion arranged to reflect light incoming from the first side towards the fourth side; and a second semi-transparent reflective portion arranged to reflect light incoming from the second side towards the fourth side, wherein light incoming from the third side passes through the first semi-transparent reflective portion and the second semi-transparent reflective portion towards the fourth side;

arranging a first display, a second display and a third display at a first distance, a second distance and a third distance from the first side, the second side and the third side of the optical combiner, respectively; and

rendering a first image, a second image and a third image at the first display, the second display and the third display such that the first image, the second image and the third image are presented at a first focal distance, a second focal distance and a third focal distance, respectively, thereby creating the three-dimensional image.

Throughout the present disclosure, the term “three-dimensional image” herein relates to an image that provides perception of depth to the viewer. Herein afterwards, the terms “user”, “viewer” “observer” and “human” have been interchangeably used without any limitations. The three-dimensional image may be a volumetric image (namely, an image having a height, a width, and a depth in the three-dimensional space). A given three-dimensional image could be a given volumetric image of at least one three-dimensional object (for example, such as a statue, a vehicle, a weapon, a musical instrument, an abstract design, and the like), a three-dimensional scene (for example, such as a beach scene, a mountainous environment, an indoor environment, and the like), and so forth. Moreover, the term “three-dimensional image” also encompasses a three-dimensional computer-generated surface. Furthermore, the term “three-dimensional image” also encompasses a three-dimensional point cloud. In an example, a sequence of three-dimensional images can relate to a three-dimensional video (such as a three-dimensional virtual game, a three-dimensional tutorial, and the like).

Further, the term “display apparatus” used herein relates to a specialized equipment for presenting the three-dimensional (3D) image to a viewer in a manner that the three-dimensional image truthfully appears to have actual physical depth. For example, conventional display systems enable presentation of two-dimensional images to viewers, such that the viewer perceives only a height and a width of an object displayed within the image across a two-dimensional plane (such as, on a display screen used for displaying the two-dimensional image). Furthermore, the display of such a two-dimensional image on the display system is associated with the viewer perceiving the object as having a unit depth (or no depth). However, the display apparatus of the present disclosure enables the viewer to perceive the two-dimensional nature of the object as well as the depth of the object displayed within the image. In other words, the display apparatus is a device for visually presenting the three-dimensional image in a three-dimensional space. Examples of such display apparatus include televisions, computer monitors, portable device displays and so forth. Further, the display apparatus includes display devices that can be positioned near eyes of a user thereof, such as, by allowing the user to wear (by mounting) the near-eye display apparatus on a head thereof. Examples of such near-eye display apparatuses include, but are not limited to, head mounted displays (HMDs), head-up displays (HUDs), virtual-reality display devices, augmented-reality display devices, and so forth. The present display apparatus can be employed in applications that require the viewer to perceive the depth of the object displayed within the image. Such a depth of the object is an actual depth (or substantially close to the actual depth) of the object as opposed to a stereoscopic depth of the object that the viewer perceives during stereoscopic reconstruction of object on a two-dimensional plane. For example, the display apparatus can be employed by a product designer designing a product using computer-modelling software to perceive the product being designed from more than one direction at a time. In another example, the display apparatus can be employed for medical application, such as, by a doctor to view a three-dimensional body-scan of a patient.

The display apparatus comprises an optical combiner having a first side, a second side, a third side and a fourth side, the second side being opposite to the first side and the fourth side being opposite to the third side. The optical combiner further comprises a first semi-transparent reflective portion arranged to reflect light incoming from the first side towards the fourth side and a second semi-transparent reflective portion arranged to reflect light incoming from the second side towards the fourth side. Herein, the light incoming from the third side passes through the first semi-transparent reflective portion and the second semi-transparent reflective portion towards the fourth side. In the present examples, the optical combiner may be made out of solid optical medium, either of glass or polymer type. In the present embodiments, the optical combiner is a x-cube beam splitter as known in the art. Herein, four given outer surfaces (or faces) of such optical combiner form the said four sides, namely the first side, the second side, the third side and the fourth side; and two diagonals of such optical combiner form the said two semi-transparent reflective portions, namely the first semi-transparent reflective portion and the second semi-transparent reflective portion. As used herein, the term “semi-transparent reflective portion” refers to a portion of the optical combiner that is partially reflective and partially transparent. The light rays passing through the semi-transparent reflective portion may encounter a reflective section which reflect the light rays and/or a transparent section which allows the light rays to pass through. In an embodiment, the first semi-transparent reflective portion and the second semi-transparent reflective portion of the optical combiner is treated with a coating of one or more semi-reflective materials. Generally, the optical combiner is a device that can converge two or more separated light beams into one single beam. In the display apparatus of present configuration, the light beams entering from the first side, the second side and the third side of the optical combiner converge and appear out of the fourth side.

As explained herein before, the images rendered using the display apparatus are three-dimensional images (referred to as “3D images” herein after). Consequently, the 3D image is divided into a plurality of image slices corresponding to the 3D image to be rendered using the display apparatus. The term “image slice” as used throughout the present disclosure, refers to each of a planar portion of a 3D image. Such image slices of the object when put together enable the display of the 3D image, such that the viewer can perceive the depth of the object displayed within the 3D image. For example, an object to be displayed with the 3D image is a spherical ball. In such an example, the image slices of the spherical ball correspond to a first set of circles, each having a bigger diameter than a preceding circle of the first set of circles and a second set of circles, each having a smaller diameter than a preceding circle of the second set of circles. Furthermore, the first set and the second set of circles are separated by a circle having a bigger diameter as compared to any circle within the first set or the second set of circles, such that the circle corresponds to a middle plane of the spherical ball. Moreover, when the image slices corresponding to the first set of circles, the circle having the biggest diameter and the second set of circles are arranged together and displayed to the viewer, the viewer perceives the depth associated with the spherical ball. Such a display of 3D images using the image slices provides a convenient technique for enabling the viewer to perceive the depth of the object displayed within the image. Furthermore, such image slices reduce a necessity for altering the images (such as, for stereoscopic reconstruction of the images), thereby, maintaining a quality (such as, image resolution and/or sharpness) of the images. Moreover, displaying of the 3D image using the image slices reduces an amount of pre-processing of the images that is required to display the depth of the image.

The display apparatus further comprises a first display, a second display and a third display arranged at a first distance, a second distance and a third distance from the first side, the second side and the third side of the optical combiner, respectively, wherein a first image, a second image and a third image rendered at the first display, the second display and the third display are presented at a first focal distance, a second focal distance and a third focal distance, respectively, thereby creating the three-dimensional image. It is to be understood that the three displays (i.e. the first display, the second display and the third display) are used for projecting images. Herein, each of the said three displays corresponds to a single focal plane, in the display apparatus. As discussed, the 3D image is processed to generate a plurality of image slices corresponding to different focal planes of the 3D image to be rendered using the display apparatus. In the present examples, the 3D image may be sliced into three images, namely the first image, the second image and the third image. Further, in present display apparatus, each of the said three displays may render (or present) one of the three images. Specifically, the first image, the second image and the third image rendered at the first display, the second display and the third display are presented at the first focal distance, the second focal distance and the third focal distance, respectively. It may be appreciated that the “focal distance” could be measured with respect to retina of a user's eye. These images may be perceived to be located at different focal planes due to the configuration and arrangement of the displays with respect to the optical combiner in the display apparatus (as discussed in more detail below), and these multiple focal planes are in turn virtually stitched together in human brain to render the 3D image. In the present configuration, the focal distance (or depth of focal planes) is distinguished by separation of displays from the eyepiece (as discussed later). As the optical combiner ensures optical paths with identical length within the display apparatus, the variation of depth placement for corresponding focal planes is determined by the distances between the sides of the optical combiner and the respective displays. As the total length of the optical path from the display to the eyepiece increases, the corresponding focal plane is perceived at a further depth by the observer.

In the display apparatus, the first display, the second display and the third display are, ideally, arranged parallel to the first side, the second side and the third side of the optical combiner, respectively. However, in practice to ideally position the said displays in respect to the said sides of optical combiner, some tilt may inevitably be introduced. As a consequence, the corresponding focal planes may not be aligned parallelly on optical axis, which will impact how the rendered 3D image is perceived and how multiple focal planes are virtually stitched together. To alleviate this effect, calibration constants may be determined for each of the first display, the second display and the third display, indicative of the misalignment (or specifically angle) of the first display, the second display and the third display with respect to the first side, the second side and the third side of the optical combiner, respectively. It may be appreciated that such calibration constants may be determined at the time of manufacturing or assembly of the display apparatus. The determined calibration constants are then taken into account in software for focal plane compensation while rendering the 3D image. Such compensation techniques may be appreciated by a person skilled in the art and thus have not been described herein for the brevity of the present disclosure.

In one or more examples, the said three displays are emissive micro-displays. The term “micro” display as used herein may refer to the descriptive size of certain devices or structures in accordance with embodiments of the present disclosure. As used herein, the term “micro” display is meant to refer to a display which has a pixel pitch on the scale of micrometres such as the scale of 2 to 100 um (micro meters). Furthermore the diagonal size of such a display can range from 1 mm to 100 mm. However, it is to be appreciated that embodiments of the present disclosure are not necessarily so limited, and that certain aspects of the embodiments may be applicable to larger, and possibly smaller size scales. In the present examples, the emissive micro-displays are one of: organic light emitting diode (OLED), solid state light emitting diode technology (μLED), and liquid crystal display (LCD) with emissive backplane. These emissive micro-displays emit light so that no additional illumination sources are needed. Such emissive micro-displays provide high power efficiency which is a critical requirement for portable near-to-eye head mounted systems or dismounted mobile systems, especially for field applications. The utilized emissive micro-displays can be of monochromatic type (emitting only a single colour) or polychromatic type (capable of reproducing true colours), without any limitations. Preferably, the emissive micro-displays are highly bright liquid crystal display (LCD). The brightness of the utilized emissive micro-displays should surpass 1000 nits but preferably it should surpass 5000 nits. In the present examples, each of the displays has a preferable aspect ratio of 1:1 to 3:4. Further, each of the displays has corresponding diagonal length in a range from 0.2 inches to 1 inch with a preferable range of 0.5 inches to 0.9 inches. Thus, the diagonal length for each of the displays may be, for example, 0.5 inches, 0.6 inches, 0.7 inches or 0.8 inches up to 0.6 inches, 0.7 inches, 0.8 inches or 0.9 inches.

Optionally, the first side, the second side, the third side and the fourth side of the optical combiner are curved. For this purpose, the surface geometry of the sides of the optical element is modified to be spherical, aspherical or freeform. Furthermore, optionally, the first side, the second side and the third side of the optical combiner have different optical strengths. Herein, the term “optical strength,” in general, refers to the degree to which the lens or the mirror or the optical system converges or diverges light. It may be contemplated that, in one example, the difference in optical strengths may be achieved by having different radii of curvature for the first side, the second side and the third side of the optical combiner. Such modified geometry of the optical combiner results in different magnification of the first image, the second image and the third image, i.e. various focal planes of the 3D image to be rendered by the display apparatus for creating the 3D image.

Optionally, the display apparatus comprises a first optical element, arranged between the first display and the first side, having a first optical strength; a second optical element, arranged between the second display and the second side, having a second optical strength; and a third optical element, arranged between the third display and the third side, having a third optical strength. Herein, each of the first optical element, the second optical element and the third optical element provide a magnification factor to the rendered focal plane of the 3D image by the corresponding display, proportional to the respective first optical strength, the second optical strength and the third optical strength. Herein, the optical elements, namely the first optical element, the second optical element and the third optical element, are passive elements. Such optical element can be one of a prism, a Fresnel lens, a refractive lens, a holographic optical element, a metamaterial lens, a flat liquid crystal-based lens and the like. As discussed, the optical combiner can either have flat sides or curved sides. In case of optical combiner having flat sides, optical strength can be attributed only to complementary optical elements; while in alternative case of the optical combiner having curved sides, the curved sides of optical combiner with respective optical strength can be complementary to the optical strength of the associated optical elements for rendering the 3D image.

Optionally, the first optical strength, the second optical strength and the third optical strength are adjustable. This means that the corresponding magnification factor of the first optical element, the second optical element and the third optical element can be adjusted to variably adjust the magnification of the first image, the second image and the third image, i.e. various focal planes of the 3D image to be rendered by the display apparatus for creating the 3D image. In the present example, the first optical element, the second optical element and the third optical element are active optical elements, such as one of: planar liquid crystal lenses, mechanically adjustable (reciprocal) lenses, electromechanical deformable lenses (liquid lenses) and the like. Furthermore, optionally, at least one of: the first optical strength, the second optical strength, the third optical strength is adjusted in a time-multiplexed manner. Herein, the term “time-multiplexing” refers to transmitting or receiving independent signals one by one in a synchronized manner so that corresponding information appears for a fraction of time, with the switching being accomplished in a progressive manner or an interlaced manner. For this purpose, the first optical element, the second optical element and the third optical element may be varifocal elements. The implementation of varifocal elements can be used to compensate for common visual impairments. Further, the first optical element, the second optical element and the third optical element, being varifocal elements, may be controlled to vary focuses thereof in a time-multiplexed manner. It may be contemplated by a person skilled in the art that the number of available focal planes is increased by time-multiplexing via varifocal elements, i.e. the first optical element, the second optical element, the third optical element.

Optionally, the display apparatus comprises a first polarizer, arranged between the first display and the first side, for polarizing light emitted by the first display at a first polarization orientation, wherein the first semi-transparent reflective portion is configured to reflect the light having the first polarization orientation towards the fourth side; and a second polarizer, arranged between the second display and the second side, for polarizing light emitted by the second display at a second polarization orientation, wherein the second semi-transparent reflective portion is configured to reflect the light having the second polarization orientation towards the fourth side. In some examples, the display apparatus also comprises a third polarizer, arranged between the third display and the third side, for polarizing light emitted by the third display at a third polarization orientation (which may be same as one of or different from the first polarization orientation and the second polarization orientation), wherein the optical combiner is configured to pass the light having the third polarization orientation towards the fourth side. Herein, the term “polarizer” refers to a type of optical filter through which light waves of only specific polarization can pass, and others are blocked. That is, the “polarizer” can filter light rays into a specific polarized beam. Example of a polarized light beam are light waves in which vibrations occur in only one plane. In addition polarized light beam can be for example circularly polarized light or light in which polarization is defined as left or right (vector) turned polarization. In some examples, the semi-transparent reflective portions of the optical combiner are treated with coating to reflect specifically polarized light beams from the polarizers associated with the corresponding displays.

The display apparatus further comprises at least one processor to process the 3D image. Notably, the processor may be a personal computer with dedicated graphics processing unit or a specialized hardware, software and/or a firmware combination. The processor can be understood to be a unit that performs processing tasks for the display apparatus. A plurality of computational tasks are conveyed for execution on the graphics processing unit by utilizing application programming interfaces (APIs), possibly in various combinations, for example, such as NVIDIA®, CUDA®, OpenCL®, DirectX®, OpenGL®, etc.

Optionally, the at least one processor is configured to obtain information indicative of optical depths of objects present in a three-dimensional scene of the three-dimensional image. The processor is further configured to determine respective focal distances at which the objects are to be presented. The processor generates the first image, the second image and the third image based on the focal distances at which the objects are to be presented. It may be appreciated that a given image is representative of a given set of objects that are to be presented at a given focal distance.

Optionally, the at least one processor is configured to control the first display, the second display and the third display to render the first image, the second image and the third image, respectively, substantially simultaneously. It may be understood that with the present display apparatus having the optical combiner in the form of x-cube beam splitter, if optical paths from the three displays to eyepiece are substantially same in length. Term substantially same refers to difference of length of two optical paths of 0 to +−1% or between 0 to +−5% in respect to each others. With the first display, the second display and the third display being controlled to render the first image, the second image and the third image, respectively, substantially simultaneously, such arrangement allows for easier fine-tuning of focal planes without additional lens elements to compensate for large optical path differences as may be encountered with arrangements with differences in lengths of optical paths. Thus, the present display apparatus is beneficial and allows to construct compact near-eye display with good optical quality (no unnecessary lens elements which would introduce optical aberrations) and fine-tuning capabilities.

Optionally, when generating the first image, the second image and the third image based on the focal distances at which the objects are to presented, the at least one processor is configured to: determine, for a given object that is to be presented at a given focal distance, whether or not an entirety of the given object can be presented at the given focal distance; when the entirety of the given object cannot be presented at the given focal distance, split the given object into a plurality of parts and present one of the plurality of parts at the given focal distance, whilst presenting at least one of the plurality of parts at a focal distance that is greater than the given focal distance; and when the entirety of the given object can be presented at the given focal distance, present the given object at the given focal distance. As may be appreciated, the viewing angle of different depth planes might be different. That is, nearer the plane, narrower the angle; and farther the plane, larger the angle. Thus, more content can be presented on a far-off plane as compared to a nearer plane. Therefore, in case all of the content of a given image to be displayed cannot be at displayed a given focal plane, one or more far-off planes can be used to extend the field of view of the nearer planes. This is done by dividing the one or more objects in the given image into parts. The parts that cannot be displayed on the nearer plane are displayed on the next far plane where it can be accommodated. Alternatively, parts of the content can be shown on intermittent depth plane as well. As the user is concentrated on the central region of the near focal plane, an effect of reduced visual acuity around the periphery can be utilized to transfer the peripheral data to the far plane. The user would be accommodating on the close distance where the image has high resolution, thus not experiencing adverse effects of vergence-accommodation conflict, while the peripheral visual field of the user would be supplemented by data on the far plane thus ensuring continuity of the scene without sharp abruptions. It may be understood that the procedure is repeated for all available intermediate focal planes, except the furthest one. Further, all focal planes are rendered in accordance to determined boundary conditions of the content.

Optionally, when presenting at least one of the plurality of parts, the at least one processor is configured to blur the at least one of the plurality of parts. As may be appreciated that for near work-oriented tasks, the attention of the user is oriented towards a smaller range and the image resolution needs to be high, and the user perceives the far planes with lesser resolution. When some of the parts of the image that cannot be displayed on the near plane are displayed on far-off plane (as discussed), some post-processing steps are required in order to make the image look natural. Herein, during image rendering, post-processing steps are executed to add selective blur to parts of the split content of a given image. One of the post-processing blur actions is extreme edge blur of the content on the near plane to blend the image parts with parts that have been transferred to far plane. In a way, this step is taken to yield a more naturally looking appearance of the image. Another post-processing blur action, is a synthetic blur of the content that should have been shown at near accommodation distance but due to restricted physical area, has been transferred to a relatively far-off plane. This is needed so as not to confuse the user, if the user switches accommodation from the near plane towards far plane. A synthetic blur of the content supposed to be displayed on a near plane onto a relatively far-off plane provides visual information in the peripheral field when the user is accommodating on the near focal distance (near-focal plane), while ensures naturalistic blur if the user decides to re-accommodate on the far plane, without the need of eye tracking device.

Optionally the display apparatus further comprises at least one magnifying optical element arranged on an optical path between the fourth side of the optical combiner and a user's eye when the display apparatus is in use. The magnifying optical element acts as an eyepiece in the display apparatus, and can be a single element eyepiece, or alternatively it can be a multi-element eyepiece. The element(s) of the magnifying optical element may include any of or combination of: a refractive lens, a Fresnel lens, a prism, a mirror, a semi-transparent mirror, a meta-surface, a holographic (diffractive) optical element, and the like. As discussed, the light beams from the three displays become aligned on a single optical axis at the exit from the fourth side of the optical combiner. The depth of focal planes is distinguished by separation of displays from the magnifying optical element. As the optical combiner ensures optical paths with identical length, the variation of depth placement for corresponding focal planes is determined by the distances between the sides of the optical combiner and the corresponding displays. As the total optical path length from the surface of any of the display to the magnifying optical element increases, at a further depth the focal plane is perceived by the user. In one or more examples, the display apparatus is configured to result in apparent (virtual) focal plane separation of 0.2 Dioptres to 1.1 Dioptres. In alternative embodiment there is at least one magnifying optical element arranged on an optical path between the first side, the second and the third side and corresponding display.

It may be appreciated that the arrangement of the optical combiner along with the corresponding displays and optical elements and assemblies, provide one display module for the display apparatus. When the display apparatus is implemented as a wearable device, such as virtual reality headsets, augmented reality headsets or mixed reality headsets, two such display modules are provided one for each eye of the user.

Optionally, the display apparatus further comprises an optical see-through combiner arranged to optically combine the created three-dimensional image with light received from a real-world environment, thereby producing an augmented-reality environment. The above described multifocal display architecture of the display apparatus along with the inclusion of the optical see-through combiner, can be implemented in wearable devices. As widely known, augmented reality (AR) is an interactive view with the blending of digital elements into real-world environments. The optical see-through combiner can be in the form of a glass or a lens arranged at an angle such that the light beams from the real-world environment are combined with the created three-dimensional image by the display apparatus. For instance, when the display apparatus is implemented in an augmented reality wearable headset, the optical see-through combiners are placed at generally 45 degrees angles with respect to corresponding one of the two display modules of the display apparatus as required for each of the two eyes of the user. The angles between the optical see-through combiners might be different depending on the implementation. For example a freeform semi reflective image combiner could be used. The freeform semi reflective image combiner would, in addition to combining, work as a magnifying eye-piece. In such a scenario the angle between combiners can deviate from said 45 degrees to such as 20-80 degrees. Furthermore if the freeform image combiner has curved structure angle between two of those vary depending on the curvature. The optical see-through combiner receives the three-dimensional image information from the corresponding display module and the light beams from the real world, which are combined to provide augmented reality view for the user. Moreover, optical see-through combiners also redirect light from the display modules towards eyes, thus aligning the light from display modules with light from the ambient scene, which consequently makes a case for composite image of augmented reality.

According to embodiments of the present disclosure, the display apparatus can be configured to vary the field-of-view (FOV) for different focal planes. The display apparatus may have an optical arrangement such that the furthest (corresponding to infinity) focal plane has a much larger FOV as compared to other (two) focal planes intended for near content. This is of special interest, where some simulation scenarios, for example, in aviation have to be implemented. In such case the instrument panel is depicted up close and doesn't require high field of view, but nevertheless, not to cause claustrophobic sensation, peripheral vision should also be provided with some graphical content. For this an enlarged furthest focal plane with larger FOV would be a good solution.

For achieving this, in a first implementation, the display apparatus comprises at least one asymmetric (i.e. curved) inner surface for semi-transparent reflective portion. The curved inner surface would expand the image from the corresponding display as the light therefrom is reflected and come out form the fourth side, thus ensuring larger FOV. In a second implementation, an additional fourth display may be provided along with the third display. The fourth display may be tilted at an angle with respect to the third display. The fourth display would complement the third display at the back virtually extending the FOV. It should be understood that the image generated by the fourth display wouldn't be combined through the optical combiner. In such case, the display apparatus may include a compound optical element which would have different optical strength regions for displays corresponding to optical combiner (i.e. the first display, the second display and the third display) and the free fourth display. Specifically, the compound optical element has a first optical strength region and a second optical strength region, with an intermediate transitional region in between. In general, the compound optical element may be a type of freeform optics. In a third implementation, which is similar to the second implementation, the display apparatus instead utilizes a curved (flexible) display as the third display, which would be beneficial for FOV expansion. Such curved display can be OLED or LCD display as flexible versions of those have been demonstrated. Herein, a single curved display can be used for the far plane where a region of the display would be combined with other focal planes through the optical combiner, and the second region would be added via the compound optical element, thus having only one focal length substantially corresponding to that of a furthest focal plane.

Generally, the display apparatus of the present disclosure may include at least two emissive displays with each of the at least two emissive displays representing a focal plane for the three-dimensional image content, wherein each of the at least two emissive displays are arranged parallel with respect to one of sides of the optical combiner at a corresponding predefined distance, and wherein the optical combiner is configured to divert light beams emitted from at least one of the at least two emissive displays by an angle such that light beams from the at least two emissive displays are aligned on a single optical axis.

The present display apparatus with multifocal display architecture is best suited for stereoscopic display systems, though it can provide benefits also in monocular display systems. As stereoscopic displays systems suffer from vergence-accommodation conflict caused human well-being issues, such as excessive eyestrain, possibly blurry vision, and others, multifocal display architecture enables 3D content to be better matched in respect to vergence and accommodation mismatch. The display apparatus enables different magnification of each focal plane corresponding to respective display element. Further, the multifocal display modules can be implemented as virtual reality headset or virtual reality headset complemented by image capturing devices, which would ensure digital combination of computer-generated content with the registered ambient scene.

It may be known that there is a problem known as “motion-to-photon latency” with AR-type headsets. As the user moves, such headsets are equipped with sensors—such as accelerometers, gyroscopic sensors, depth cameras, and other means which allow tracking of the headset in space. To adjust the digital content to the real-world environment, the image rendering pipeline is setup as follows: detect position, send detected position to computational unit, use the obtained values into consideration when rendering an updated 3D scene, send the 3D scene to display. Nevertheless, it is obvious, that when the user is in motion, the motion could be considerably faster than the latency for rendering the image. Thus, the rendered content may not correspond to actual reality, which can appear as an image blur, or jitter. This is a compound effect of sensor response time, data transfer and computation. The present display apparatus can be configured to mitigate these effects by predictive rendering algorithms. For example, data from accelerometer are used to predict what 3D image has to be rendered, so that the output content would correspond to actual position of headset (observer). The processor in the display apparatus may calculate latency of the motion-to-photon pipeline which can be measured by known techniques. In the present display apparatus, sensors module (including accelerometers, gyroscopes, cameras etc., also referred to as “spatial positioning sensory array”) is communicably coupled to a computer where graphics processing is taking place as well as to the electronics of the headset which receives and decodes the graphics. This allows to introduce minor last moment changes to the output graphics thus improving the predictive algorithm. In one example, the re-computation of received image frames would occur on FPGA chip within the driving electronics of the headset just prior to its output. For example, based on the accelerometer data, a predictive algorithm may have rendered substantially correct scene whereas the user may have additionally tilted the head briefly afterwards in a time slot between the sensor data have been sent to the main rendering engine and the rendered data have been transferred back to the display unit. Minor “last-minute” positional corrections can be directly accounted for, if the sensor data with a very low latency are directly supplied to the processing unit within the headset. Therefore, the sensor array is communicably coupled to both computational units, the graphical unit (running main rendering engine) and to the direct driver unit of the near-to-eye display, which is configured to execute simple rendering tasks—such as rotation (tilt compensation) or slight translation of the rendered image towards either side and similar. Minor remapping of pixels to new coordinates by the near-to-eye display's driving computational unit is an effective process which doesn't introduce notable latency.

The disclosed display apparatus attempts to solve size issue and place the multifocal display architecture via emissive displays into a reasonable footprint to be mounted in a wearable display device. The present display apparatus in respect to other multifocal approaches, which are typically based on a time-multiplexed output of graphical data, outputs all image planes substantially simultaneously (from vision point of view i.e. there can be an image on each of the image planes at the same time). Term substantially simultaneously can refer for example a computational delay between rendering images or for delay which is non visible for human eye (such as less than 1/20 second), This effectively reduces perceived image flicker, and facilitates high image update rate, and further eliminates colour break-up which is associated with field-sequential data output using spatial light modulators—such as LCOS or DLP technology.

Moreover, the present description also relates to the method for rendering three-dimensional image as described above. The various embodiments and variants disclosed above apply mutatis mutandis to the method for rendering the three-dimensional image.

Optionally, the first side, the second side, the third side and the fourth side of the optical combiner are curved.

Optionally, the first side, the second side and the third side have different radii of curvature.

Optionally, the method further comprises: arranging a first optical element between the first display and the first side, having a first optical strength; arranging a second optical element between the second display and the second side, having a second optical strength; and arranging a third optical element between the third display and the third side, having a third optical strength.

Optionally, first optical strength, the second optical strength and the third optical strength are adjustable.

Optionally, the method comprises adjusting at least one of: the first optical strength, the second optical strength, the third optical strength in a time-multiplexed manner.

Optionally, the method further comprises arranging an optical see-through combiner to optically combine the created three-dimensional image with light received from a real-world environment, thereby producing an augmented-reality environment.

Optionally, the method further comprises arranging a first polarizer between the first display and the first side, for polarizing light emitted by the first display at a first polarization orientation, wherein the first semi-transparent reflective portion is configured to reflect the light having the first polarization orientation towards the fourth side; and arranging a second polarizer between the second display and the second side, for polarizing light emitted by the second display at a second polarization orientation, wherein the second semi-transparent reflective portion is configured to reflect the light having the second polarization orientation towards the fourth side.

Optionally, the method further comprises of controlling the first display, the second display and the third display to render the first image, the second image and the third image, respectively, substantially simultaneously.

Optionally, the method further comprises of obtaining information indicative of optical depths of objects present in a three-dimensional scene; determining respective focal distances at which the objects are to be presented; and generating the first image, the second image and the third image based on the focal distances at which the objects are to be presented.

Optionally, the method of generating the first image, the second image and the third image further comprises: determining, for a given object that is to be presented at a given focal distance, whether or not an entirety of the given object can be presented at the given focal distance; when the entirety of the given object cannot be presented at the given focal distance, splitting the given object into a plurality of parts and present one of the plurality of parts at the given focal distance, whilst presenting at least one of the plurality of parts at a focal distance that is greater than the given focal distance; and when the entirety of the given object can be presented at the given focal distance, presenting the given object at the given focal distance.

Optionally, the method further comprises step of presenting at least one of the pluralities of parts, further comprises blurring the at least one of the plurality of parts.

Optionally, the method further comprises arranging at least one magnifying optical element on an optical path between the fourth side of the optical combiner and a user's eye when the display apparatus is in use.

### DETAILED DESCRIPTION OF THE DRAWINGS

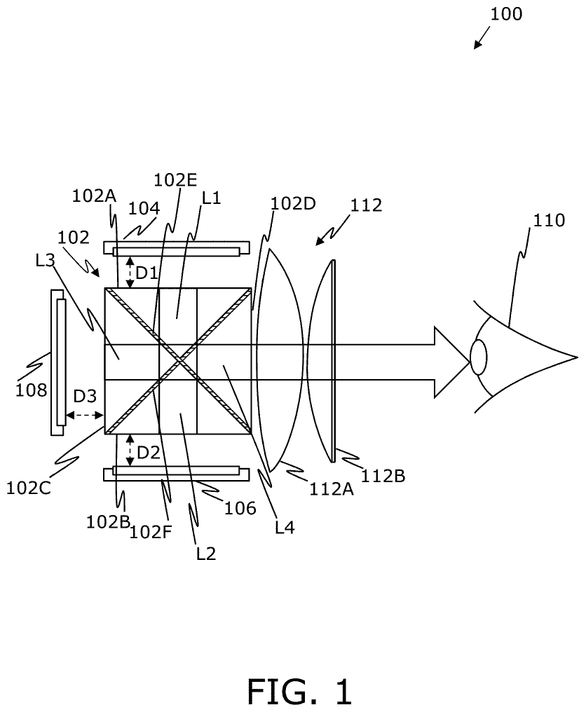

Referring to FIG. 1, there is shown a schematic illustration of a display apparatus 100 for rendering a three-dimensional image, in accordance with an embodiment of the present disclosure. The display apparatus 100 comprises an optical combiner 102 having a first side 102A, a second side 102B, a third side 102C and a fourth side 102D, the second side 102B being opposite to the first side 102A, the fourth side 102D being opposite to the third side 102C. Moreover, the optical combiner 102 comprises a first semi-transparent reflective portion 102E arranged to reflect light L1 incoming from the first side 102A towards the fourth side 102D; and a second semi-transparent reflective portion 102F arranged to reflect light L2 incoming from the second side 102B towards the fourth side 102D, wherein light L3 incoming from the third side 102C passes through the first semi-transparent reflective portion 102E and the second semi-transparent reflective portion 102F towards the fourth side 102D.

The display apparatus 100 also comprises a first display 104, a second display 106 and a third display 108 arranged at a first distance D1, a second distance D2 and a third distance D3 from the first side 102A, the second side 102B and the third side 102C of the optical combiner 102, respectively, wherein a first image (not shown), a second image (not shown) and a third image (not shown) rendered at the first display 104, the second display 106 and the third display 108 are presented at a first focal distance (not shown), a second focal distance (not shown) and a third focal distance (not shown), respectively, thereby creating the three-dimensional image (not shown).

The first semi-transparent reflective portion 102E and the second semi-transparent reflective portion 102F reflect lights L1 and L2 incoming from the first display 104 and the second display 106, respectively. The first semi-transparent reflective portion 102E and the second semi-transparent reflective portion 102F divert the lights L1 and L2 by an angle substantially similar to 90 degrees, while light L3 incoming from the third display 108 passes through the first semi-transparent reflective portion 102E and the second semi-transparent reflective portion 102F without being reflected. As a result, the lights L1, L2 and L3 become aligned on a single optical axis at the exit of the optical combiner 102 to form a combined polarized light L4 to reach the visual receptors of an observer, i.e. user's eyes 110.

The display apparatus 100 further comprises at least one magnifying optical element 112 arranged on an optical path between the fourth side 102D of the optical combiner 102 and a user's eye 110 when the display apparatus 100 is in use. As shown, the at least one magnifying optical element 112 is a multi-element at least one magnifying optical element with at least two optical elements 112A and 1128.

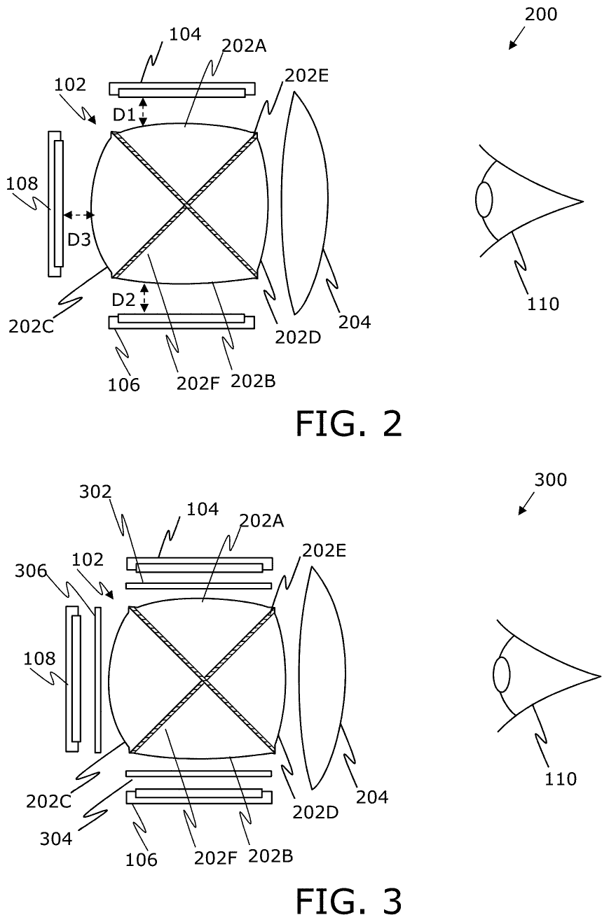

Referring to FIG. 2, there is shown a schematic illustration of a display apparatus 200 for rendering a three-dimensional image, in accordance with another embodiment of the present disclosure. It will be appreciated that the display apparatus 200 is functionally and structurally substantially similar to the display apparatus 100 of FIG. 1. For example, the display apparatus 200 includes an optical combiner 102 and a first display 104, a second display 106 and a third display 108. However, the optical combiner 102 has a first side 202A, a second side 202B, a third side 202C and a fourth side 202D, the second side 202B being opposite to the first side 202A, the fourth side 202D being opposite to the third side 202C. Moreover, the first side 202A, the second side 202B, the third side 202C and the fourth side 202D are curved (for example spherical, aspherical or free-form curvature), with similar or different radii of curvature, respectively. The optical combiner 102 also comprises a first semi-transparent reflective portion 202E and a second semi-transparent reflective portion 202F. The first display 104, the second display 106 and the third display 108 are arranged at a first distance D1, a second distance D2 and a third distance D3 from the first side 202A, the second side 202B and the third side 202C of the optical combiner 102, respectively. The first display 104, the second display 106 and the third display 108 have a substantially identical length of optical path to the at least one magnifying optical element 204.

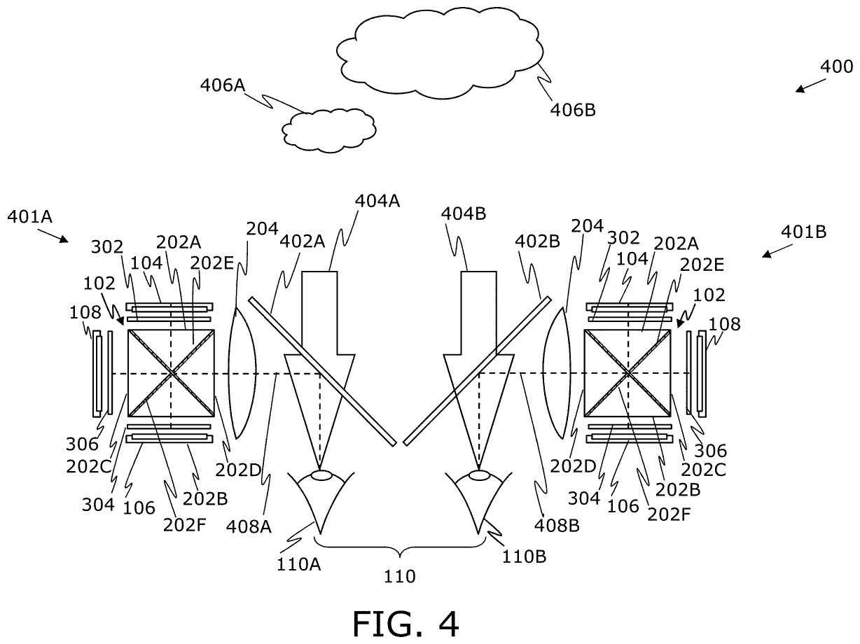

Referring to FIG. 3, there is shown a schematic illustration of a display apparatus 300 for rendering a three-dimensional image, in accordance with yet another embodiment of the present disclosure. It will be appreciated that the display apparatus 300 is functionally and structurally substantially similar to the display apparatus 200 of FIG. 2. For example, the display apparatus 300 includes an optical combiner 102 having a first side 202A, a second side 202B, a third side 202C and a fourth side 202D, the second side 202B being opposite to the first side 202A, the fourth side 202D being opposite to the third side 202C. Moreover, the first side 202A, the second side 202B, the third side 202C and the fourth side 202D are curved (for example spherical, aspherical or free-form curvature), with similar of different radius of curvature, respectively. The optical combiner 102 also comprises a first semi-transparent reflective portion 202E and a second semi-transparent reflective portion 202F. The display apparatus 300 includes a first display 104, a second display 106 and a third display 108. The first display 104, the second display 106 and the third display 108 are arranged at a first distance D1, a second distance D2 and a third distance D3 from the first side 202A, the second side 202B and the third side 202C of the optical combiner 102, respectively. Herein, the display apparatus 300 further includes a first optical element 302 arranged between the first display 104 and the first side 202A, having a first optical strength; a second optical element 304 arranged between the second display 106 and the second side 202B, having a second optical strength; and a third optical element 304 arranged between the third display 108 and the third side 202C, having a third optical strength. The first optical strength, the second optical strength and the third optical strength are adjustable, in a time-multiplexed manner.

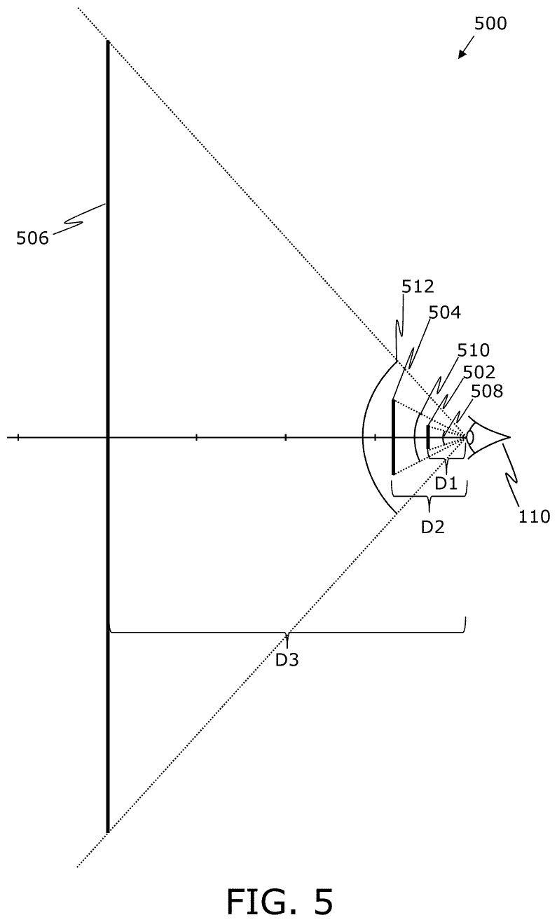

Referring to FIG. 4, there is shown a schematic illustration of a display apparatus 400 for rendering a three-dimensional image, in accordance with an exemplary implementation of the present disclosure. The display apparatus 400 is implemented as a wearable display device, such as a virtual reality headset, an augmented reality headset, a mixed reality headset and so forth. The display apparatus 400 comprises two display modules 401A and 401B which are functionally and structurally substantially similar to the display apparatus 300 of FIG. 3. The display apparatus 400 further comprises two optical see-through combiner 402A and 402B arranged to optically combine the created three-dimensional images by the display modules 401A and 401B with light 404A and 404B received from a real-world environment 406A and 406B, thereby producing an augmented-reality environment. In this case, the viewer 110 can optically see the light 404A and 404B received from real-world environment 406A and 406B, which enters the eyes 110A and 1108 of the viewer 110 through the optical see-through combiner 402A and 402B. Moreover, the optical see-through combiner 402A and 402B also redirect light 408A and 408B received from the display modules 401A and 401B towards the viewer's eyes 110A and 1108, thus aligning the light 408A and 408B with light 404A and 404B, which consequently makes a case for composite image of augmented reality.

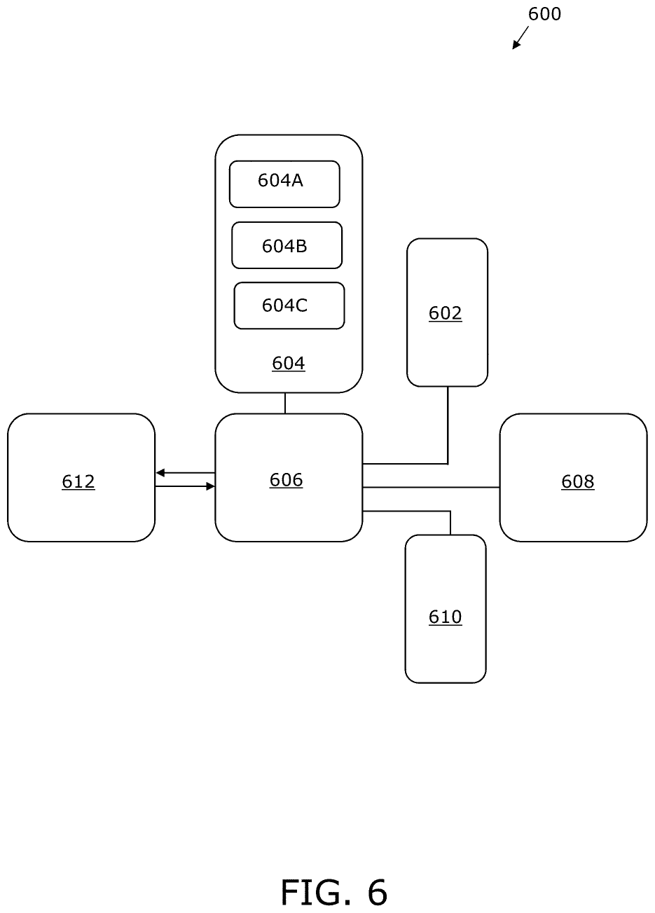

Referring to FIG. 5, there is shown a schematic illustration of appearance of virtual focal planes as generated by for example display apparatus 100 of FIG. 1 (as well as FIGS. 2, 3, 4). The display apparatus 100 generates three focal (depth) planes 502, 504 and 506 which are chosen to depict a content within a wide range. The focal planes 502, 504 and 506 are placed for near-work oriented tasks, with the closest focal plane 502 preferably is located at around 2.5D distance (i.e. around 0.4 m). The second furthest focal plane 504 is located at around 1.25 D distance (i.e. around 0.8 m) while the furthest focal plane 506 is preferably located at 0.2D±0.15D (i.e. about 2.85 m-20 m). In such configuration for the majority of 3D content, the vergence-accommodation mismatch doesn't surpass 1.25D. In alternative example the plane 506 can be used to render object(s) which are far way or at infinity.

Furthermore, in the schematic illustration there might be varying magnification across all focal planes contributing to near-work oriented display system. For near-work oriented tasks, a user is concentrating attention in a relatively narrow zone, where high image resolution is required. As shown in FIG. 5, viewing angles 508, 510 and 512 for each of focal planes 502, 504 and 506 is different, that is for the close or near focal planes, the viewing angles 508, and 510 are considerably narrower than for the far focal plane viewing angle 512. The horizontal viewing angle for near focal planes (perceptually located closer than 1 m away) is between 20 degrees and 65 degrees, while the vertical viewing angle preferably is between 10 degrees and 50 degrees. If similar image sources are used for all focal planes 502, 504 and 506. a narrower viewing angle for near focal planes translates to higher angular resolution, and it is needed the most especially for near-work tasks. For the far plane, the preferable horizontal viewing angle is between 70 and 150 degrees, while vertical viewing angle preferably is between 40 and 110 degrees. In such case, the far plane is used for depiction of background information, which can be of lower angular resolution as compared to image displayed on the near planes.

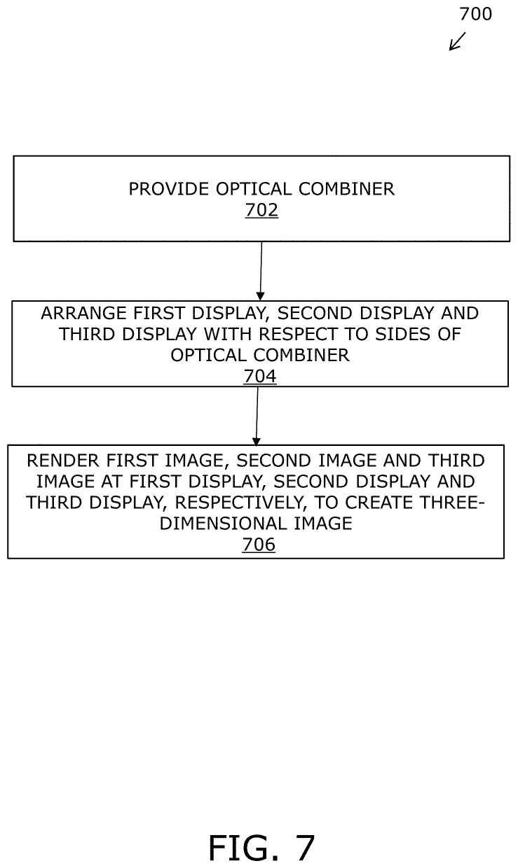

Referring to FIG. 6, there is shown a block diagram of a display apparatus 600 for rendering a three-dimensional image, in accordance with another exemplary implementation of the present disclosure. The display apparatus 600 comprises an optical combiner 602 and a display unit 604 comprising a first display 604A, a second display 604B and a third display 604C. The display apparatus 600 further comprises at least one processor 606 configured to control the first display 604A, the second display 604B and the third display 604C (collectively, referred to as “displays”) to render the first image, the second image and the third image, respectively, substantially simultaneously. The at least one processor 606 receives video data stream decodes, buffers and transfers it to the display unit 604 which contains individual displays 604B, 604B and 604C corresponding to a given image depth (focal) planes. Further, the at least one processor 606 is communicably coupled to varifocal elements 610 (including a first optical element, a second optical element, a third optical element and at least one magnifying optical element), which receives configurational commands from at least one processor unit 606 in accordance to rendering and/or configurational parameters. The at least one processor 606 is communicably coupled to an external processing unit 612. The communication between units 606 and 612 is bidirectional and can be ensured via wired or wireless communication links ensuring substantially high data bandwidth in the direction from the processing unit 612 to the processor 606, and vice-versa. As shown, the at least one processor 606 is communicably coupled with a gaze tracking unit 608. Further, as the data about gaze direction is received by the at least one processor 606 from the gaze tracking unit 608, it transmits the data to the external processing unit 612, where this data is taken into account when rendering the three-dimensional image.

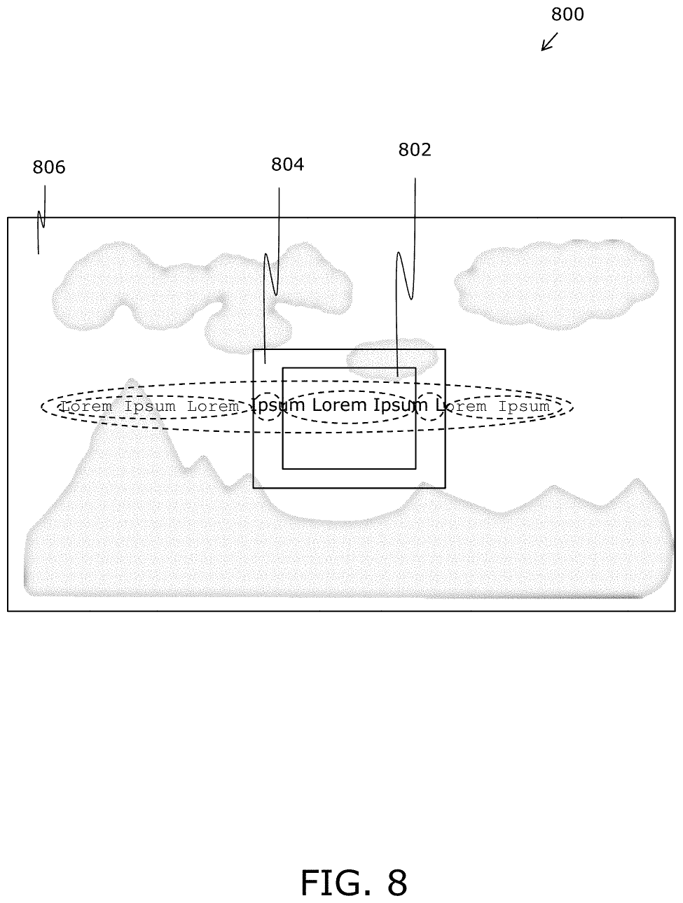

Referring to FIG. 7, there is shown a flowchart 700 of a method for rendering a three-dimensional image, in accordance with an embodiment of the present disclosure. The method comprises, at step 702, providing an optical combiner having a first side, a second side, a third side and a fourth side, the second side being opposite to the first side, the fourth side being opposite to the third side, the optical combiner comprising a first semi-transparent reflective portion arranged to reflect light incoming from the first side towards the fourth side; and a second semi-transparent reflective portion arranged to reflect light incoming from the second side towards the fourth side, wherein light incoming from the third side passes through the first semi-transparent reflective portion and the second semi-transparent reflective portion towards the fourth side; at step 704, arranging a first display, a second display and a third display at a first distance, a second distance and a third distance from the first side, the second side and the third side of the optical combiner, respectively; and at step 706, rendering a first image, a second image and a third image at the first display, the second display and the third display such that the first image, the second image and the third image are presented at a first focal distance, a second focal distance and a third focal distance, respectively, thereby creating the three-dimensional image.

The steps 702, 704 and 706 are only illustrative and other alternatives can also be provided where one or more steps are added, one or more steps are removed, or one or more steps are provided in a different sequence without departing from the scope of the claims herein.

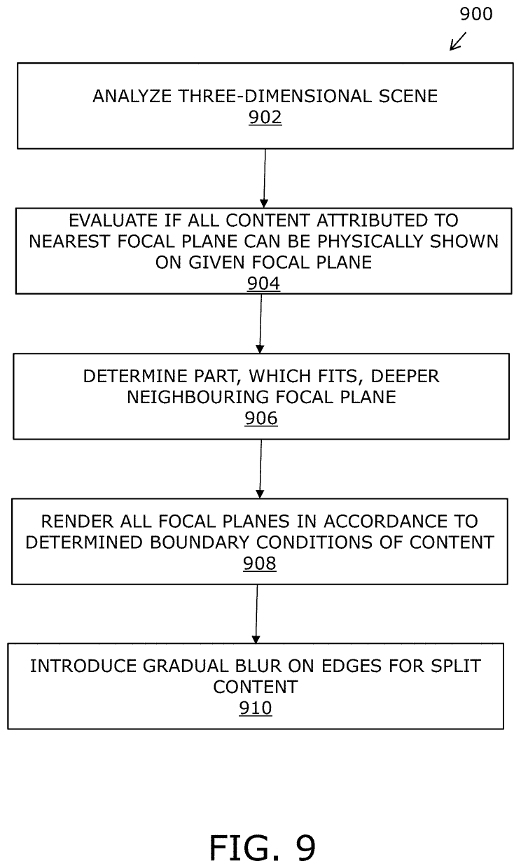

Referring to FIG. 8, there is shown a depiction of a rendered three-dimensional image 800, in accordance with one embodiment of the present disclosure. The image 800 is rendered in far plane 806, intermediate plane 804 and near plane 802. As shown, the three-dimensional image 800 is generated by post-processing during image rendering, which adds selective blur to parts of the split content such as (a) an extreme edge blur of the content on the near plane 802 to blend the image parts with parts that have been transferred to a far plane 806 (or intermediate plane 804) to yield a more naturally looking appearance of the image; or (b) a synthetic blur of the content that should have been shown at near accommodation distance (such as near plane 802 or intermediate plane 804) but due to restricted physical area, has been transferred to the far plane.

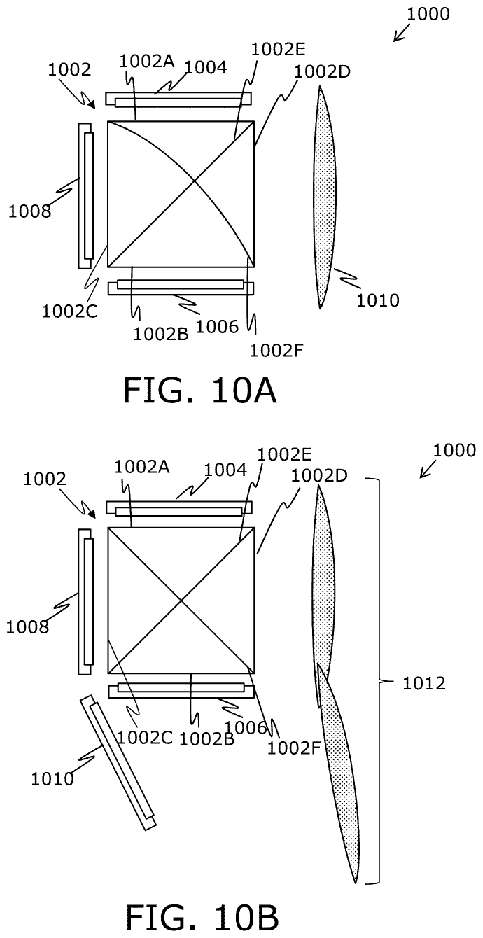

FIG. 9 is a flowchart 900 listing steps of a method for rendering a three-dimensional image, in accordance with another embodiment of the present disclosure. The method includes, at a step 902, analysing a three-dimensional scene, assigning an optical depth, and arranging content among available optical depth planes. The method includes, at a step 904, evaluating if all the content attributed to the nearest focal plane can be physically shown on a given focal plane, and repeating the procedure for all available focal planes, except the furthest one (with the largest viewing angle). If not, the method includes, at a step 906, determining the part, which fits, the deeper neighbouring focal plane which is not the furthest plane. If the display device is equipped with more intermediate focal planes, this procedure is repeated for those focal planes until the part that would be shown on the furthest (widest) focal plane is determined. The method further includes repeating the procedure for all available intermediate focal planes, except the furthest one. The method includes, at a step 908, rendering all focal planes in accordance to determined boundary conditions of the content, based on data determined in previous steps. The method includes, at a step 910, performing the post-processing step, to introduce gradual blur on edges for the split content. Alternatively, this step can be a part of previous step and can be performed prior summation of pixels. The method further includes outputting focal planes to the display apparatus, such as the display apparatus 100 of FIG. 1, or the display apparatus 200 of FIG. 2, or the display apparatus 300 of FIG. 3, or the display apparatus 400 of FIG. 4.

The steps 902, 904, 906, 908 and 910 are only illustrative and other alternatives can also be provided where one or more steps are added, one or more steps are removed, or one or more steps are provided in a different sequence without departing from the scope of the claims herein.

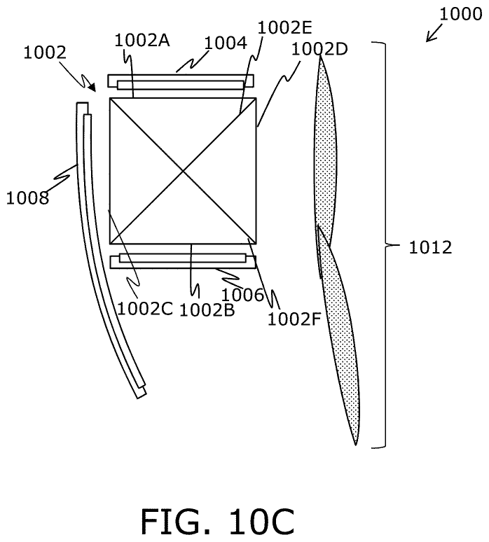

Referring to FIGS. 10A-10C, there are shown schematic illustrations of different configurations of display apparatus 1000 for rendering a three-dimensional image corresponding to respective configurations, in accordance with various exemplary implementations of the present disclosure. The field of view varies for different focal planes due to the choice of different optical arrangements. The display apparatus 1000 comprises an optical combiner 1002 having a first side 1002A, a second side 1002B, a third side 1002C, a fourth side 1002D, a first semi-transparent reflective portion 1002E and a second semi-transparent reflective portion 1002F. The display apparatus 1000 also comprises a first display 1004, a second display 1006 and a third display 1008.

As shown in FIG. 10A, the first semi-transparent reflective portion 1002E and the second semi-transparent reflective portion 1002F are asymmetric where the first semi-transparent reflective portion 1002E is curved having a predefined radius of curvature while the second semi-transparent reflective portion 1002F is straight. The curved surface of the first semi-transparent reflective portion 1002E expands the image received from the third display 1008 thereby ensuring a further larger field of view 1010.

As shown in FIG. 10B, the display apparatus 1000 further comprises a fourth display 1010, wherein the fourth display 1010 is arranged with the third display 1008. Herein, the fourth display 1010 is tilted at an angle with respect to the third display 1008. The fourth display 1010 virtually extends the field of view 1012 of the third display 1008. This is achieved using at least one compound optical element 1012 having one optical strength region corresponding to the first display 1004, the second display 1006 and the third display 1008, and a second optical strength region (different than the first optical strength region) corresponding to the fourth display 1010, thereby ensuring a further larger field of view 1012.

As shown in FIG. 100, the third display 1008 is a curved (using flexible OLED or LCD) display. The curved configuration of the third display 1008 expands the field of view 1010. This is achieved using at least one compound optical element 1012 having one optical strength region corresponding to a first portion of third display 1008 and a second optical strength region (different than the first optical strength region) corresponding to a second portion of the third display 1008, thereby ensuring a further larger field of view 1012.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A display apparatus for rendering a three-dimensional image, comprising:
an optical combiner having a first side, a second side, a third side and a fourth side, the second side being opposite to the first side, the fourth side being opposite to the third side, the optical combiner comprising:
a first semi-transparent reflective portion arranged to reflect light incoming from the first side towards the fourth side; and
a second semi-transparent reflective portion arranged to reflect light incoming from the second side towards the fourth side,
wherein light incoming from the third side passes through the first semi-transparent reflective portion and the second semi-transparent reflective portion towards the fourth side; and
a first display, a second display and a third display arranged at a first distance, a second distance and a third distance from the first side, the second side and the third side of the optical combiner, respectively, wherein a first image, a second image and a third image rendered at the first display, the second display and the third display are presented at a first focal distance, a second focal distance and a third focal distance, respectively, thereby creating the three-dimensional image.

2. The display apparatus of claim 1, wherein the first side, the second side, the third side and the fourth side of the optical combiner are curved.

3. The display apparatus of claim 2, wherein the first side, the second side and the third side have different optical strengths.

4. The display apparatus of claim 1, further comprising:
a first optical element, arranged between the first display and the first side, having a first optical strength;
a second optical element, arranged between the second display and the second side, having a second optical strength; and
a third optical element, arranged between the third display and the third side, having a third optical strength.

5. The display apparatus of claim 4, wherein the first optical strength, the second optical strength and the third optical strength are adjustable.

6. The display apparatus of claim 4, wherein at least one of: the first optical strength, the second optical strength, the third optical strength is adjusted in a time-multiplexed manner.

7. The display apparatus of claim 1, further comprising an optical see-through combiner arranged to optically combine the created three-dimensional image with light received from a real-world environment, thereby producing an augmented-reality environment.

8. The display apparatus of claim 1, further comprising:
a first polarizer, arranged between the first display and the first side, for polarizing light emitted by the first display at a first polarization orientation, wherein the first semi-transparent reflective portion is configured to reflect the light having the first polarization orientation towards the fourth side; and
a second polarizer, arranged between the second display and the second side, for polarizing light emitted by the second display at a second polarization orientation, wherein the second semi-transparent reflective portion is configured to reflect the light having the second polarization orientation towards the fourth side.

9. The display apparatus of claim 1, further comprising at least one processor configured to control the first display, the second display and the third display to render the first image, the second image and the third image, respectively, substantially simultaneously.

10. The display apparatus of claim 9, wherein the at least one processor is configured to:
obtain information indicative of optical depths of objects present in a three-dimensional scene;
determine respective focal distances at which the objects are to be presented; and
generate the first image, the second image and the third image based on the focal distances at which the objects are to be presented.

11. The display apparatus of claim 10, wherein, when generating the first image, the second image and the third image based on the focal distances at which the objects are to presented, the at least one processor is configured to:
determine, for a given object that is to be presented at a given focal distance, whether or not an entirety of the given object can be presented at the given focal distance;
when the entirety of the given object cannot be presented at the given focal distance, split the given object into a plurality of parts and present one of the plurality of parts at the given focal distance, whilst presenting at least one of the plurality of parts at a focal distance that is greater than the given focal distance; and
when the entirety of the given object can be presented at the given focal distance, present the given object at the given focal distance.

12. The display apparatus of claim 11, wherein, when presenting at least one of the plurality of parts, the at least one processor is configured to blur the at least one of the plurality of parts.

13. The display apparatus of claim 1, further comprising at least one magnifying optical element arranged on an optical path between the fourth side of the optical combiner and a user's eye when the display apparatus is in use.

14. A method for rendering a three-dimensional image, comprising:
providing an optical combiner having a first side, a second side, a third side and a fourth side, the second side being opposite to the first side, the fourth side being opposite to the third side, the optical combiner comprising a first semi-transparent reflective portion arranged to reflect light incoming from the first side towards the fourth side; and a second semi-transparent reflective portion arranged to reflect light incoming from the second side towards the fourth side, wherein light incoming from the third side passes through the first semi-transparent reflective portion and the second semi-transparent reflective portion towards the fourth side;
arranging a first display, a second display and a third display at a first distance, a second distance and a third distance from the first side, the second side and the third side of the optical combiner, respectively; and
rendering a first image, a second image and a third image at the first display, the second display and the third display such that the first image, the second image and the third image are presented at a first focal distance, a second focal distance and a third focal distance, respectively, thereby creating the three-dimensional image.

15. The method of claim 14, wherein the first side, the second side, the third side and the fourth side of the optical combiner are curved.

16. The method of claim 15, wherein the first side, the second side and the third side have different optical strengths.

17. The method of claim 14, further comprising:
arranging a first optical element between the first display and the first side, having a first optical strength;
arranging a second optical element between the second display and the second side, having a second optical strength; and
arranging a third optical element between the third display and the third side, having a third optical strength.

18. The method of claim 17, wherein the first optical strength, the second optical strength and the third optical strength are adjustable.

19. The method of claim 17 further comprising adjusting at least one of: the first optical strength, the second optical strength, the third optical strength in a time-multiplexed manner.

20. The method of claim 14 further comprising arranging an optical see-through combiner to optically combine the created three-dimensional image with light received from a real-world environment, thereby producing an augmented-reality environment.

21. The method of claim 14 further comprising:
arranging a first polarizer between the first display and the first side, for polarizing light emitted by the first display at a first polarization orientation, wherein the first semi-transparent reflective portion is configured to reflect the light having the first polarization orientation towards the fourth side; and
arranging a second polarizer between the second display and the second side, for polarizing light emitted by the second display at a second polarization orientation, wherein the second semi-transparent reflective portion is configured to reflect the light having the second polarization orientation towards the fourth side.

22. The method of claim 14 further comprising controlling the first display, the second display and the third display to render the first image, the second image and the third image, respectively, substantially simultaneously.

23. The method of claim 22 further comprising:
obtaining information indicative of optical depths of objects present in a three-dimensional scene;
determining respective focal distances at which the objects are to be presented; and
generating the first image, the second image and the third image based on the focal distances at which the objects are to be presented.

24. The method of claim 23, wherein the step of generating the first image, the second image and the third image further comprises:
determining, for a given object that is to be presented at a given focal distance, whether or not an entirety of the given object can be presented at the given focal distance;
when the entirety of the given object cannot be presented at the given focal distance, splitting the given object into a plurality of parts and present one of the plurality of parts at the given focal distance, whilst presenting at least one of the plurality of parts at a focal distance that is greater than the given focal distance; and
when the entirety of the given object can be presented at the given focal distance, presenting the given object at the given focal distance.

25. The method of claim 24, wherein the step of presenting at least one of the plurality of parts, further comprises blurring the at least one of the plurality of parts.

26. The method of claim 14 further comprising arranging at least one magnifying optical element on an optical path between the fourth side of the optical combiner and a user's eye.
